(19) United States
(12) Patent Application Publication
(10) Pub. No.: US 2025/0258534 A1
(43) Pub. Date: Aug. 14, 2025

(54) SYSTEM POWER-SAVING OPERATION DEVICE, AND SYSTEM POWER-SAVING OPERATION METHOD

(71) Applicant: NEC Corporation, Tokyo (JP)

(72) Inventors: Takuya KUWAHARA, Tokyo (JP); Kenichi SENOO, Tokyo (JP); Hiroaki TAKAI, Tokyo (JP)

(73) Assignee: NEC Corporation, Tokyo (JP)

(21) Appl. No.: 19/027,200

(22) Filed: Jan. 17, 2025

(30) Foreign Application Priority Data
Feb. 13, 2024 (JP) 2024-019274

(51) Int. Cl. G06F 1/3234

(52) U.S. Cl. CPC G06F 1/3234

(57) ABSTRACT

The system power-saving operation device includes a design unit that designs a configuration of a DAG (disaggregated) node included in a DAG system, based on the amount of resources required for service operation on the DAG system, so that a service can be operated at a level that meets a required performance requirement and power consumption is minimized, and a control unit that controls the configuration of the DAG node included in the DAG system based on the designed configuration.

This application is based upon and claims the benefit of priority from the prior Japanese Patent Application No. 2024-019274, filed Feb. 13, 2024, the entire contents of which are incorporated herein by reference.

### BACKGROUND OF INVENTION

### Field of the Invention

This present disclosure relates to a system power-saving operation device, a system power-saving operation method, and a system power-saving operation program.

### Description of the Related Art

Generally, systems for operating services are composed of integrated information processing units (hereinafter referred to as “integrated servers”) that combine devices necessary for executing software, such as a CPU (Central Processing Unit), RAM (Random Access Memory), HDD (Hard Disk Drive), and additional auxiliary processing units specialized for specific purposes, such as a GPU (Graphics Processing Unit) or other specialized computational devices. These integrated servers are treated as single units, and multiple such units are combined as needed to form the system.

In combining integrated servers, network connections facilitated by NICs (Network Interface Cards) installed in the integrated servers are used. By exchanging data with one another as needed, the interconnected integrated servers can operate as a single system.

Recently, an idea has been proposed to operate systems not as general systems based on integrated servers, but as systems where individual devices comprising the integrated servers are interconnected and can be reconfigured on a device-by-device basis. In such systems, host application instances appear to operate on virtual information processing devices (hereinafter referred to as “DAG nodes”) composed of the necessary devices for their operation. This system architecture, known as disaggregated computing, has been developed to enable more flexible and dynamic reconfigurations for optimal service operation, which is difficult to achieve with integrated servers.

In a system adopting a disaggregated computing architecture, referred to as a disaggregated system (hereinafter referred to as “DAG system”), it is possible to achieve a more flexible configuration compared to systems based on conventional integrated servers as single units. Utilizing this characteristic, for example, an application that consumes a large amount of memory during operation but functions without issues on a low-spec CPU can dynamically select and operate on a node configured with a low-spec CPU and large-capacity memory. In contrast, systems using conventional integrated servers can only choose combinations fixed by existing devices. Therefore, DAG systems enable service operations with more flexible configurations than those possible with conventional integrated server-based systems.

In general systems based on integrated servers, selecting configurations that operate services (or application instances composing the services) as efficiently as possible can reduce the total power consumption of system operation.

For example, Patent Literature 1 describes a method for estimating power consumption corresponding to workload and allocating tasks to minimize the total power consumption of the system. Such methods represent efforts to minimize the power consumption of systems running multiple services.

Patent Literature 2 describes a method for analyzing the relationship between workload and power consumption for each integrated server in a system and allocating tasks to minimize the total power consumption of the system.
[Patent Literature 1] Japanese Patent No. 5422729
[Patent Literature 2] Japanese Patent No. 5161277

### SUMMARY OF INVENTION

The conventional power-saving operation methods described above are designed to optimize general systems composed of integrated servers. In contrast, DAG systems possess a more flexible configuration capability than conventional integrated server systems. Therefore, in theory, DAG systems have the potential to achieve higher efficiency in power savings that are not feasible with the power-saving operation methods for conventional systems.

However, it is not possible to simply apply the power-saving configuration transition methods designed for general systems, as described in Patent Literature 1 and Patent Literature 2, to DAG systems.

The present disclosure aims to address the aforementioned issues by providing a system power-saving operation device, a system power-saving operation method, and a system power-saving operation program that enable power-saving operation of DAG systems.

The system power-saving operation device according to the present disclosure includes a design unit that designs a configuration of a DAG (disaggregated) node included in a DAG system, based on the amount of resources required for service operation on the DAG system, so that a service can be operated at a level that meets a required performance requirement and power consumption is minimized, and a control unit that controls the configuration of the DAG node included in the DAG system based on the designed configuration.

The system power-saving operation method according to the present disclosure includes designing a configuration of a DAG (disaggregated) node included in a DAG system, based on the amount of resources required for service operation on the DAG system, so that a service can be operated at a level that meets a required performance requirement and power consumption is minimized, and controlling the configuration of the DAG node included in the DAG system based on the designed configuration.

The system power-saving operation program according to the present disclosure for causing a computer to execute processing includes designing a configuration of a DAG (disaggregated) node included in a DAG system, based on the amount of resources required for service operation on the DAG system, so that a service can be operated at a level that meets a required performance requirement and power consumption is minimized, and controlling the configuration of the DAG node included in the DAG system based on the designed configuration.

According to the present disclosure, it is possible to operate a DAG system in a power-saving manner.

### BRIEF DESCRIPTION OF THE DRAWINGS

FIG. 1 It depicts a block diagram illustrating a configuration example of a system power-saving operation device according to the present disclosure.

FIG. 2 It depicts a flowchart illustrating an overall outline of the operation of a system power-saving operation device 100 when performing power-saving operation on a target system.

FIG. 3 It depicts a flowchart illustrating the detailed operation of a function for utilizing resource usage amounts by a resource usage management unit 102.

FIG. 4 It depicts a flowchart illustrating the detailed operation of a configuration design unit 103.

FIG. 5 It depicts a flowchart illustrating the detailed operation of a DAG system control unit 104.

FIG. 6 It depicts a block diagram illustrating another configuration example of the system power-saving operation device according to the present disclosure.

FIG. 7 It depicts a flowchart illustrating the operation of a configuration design unit 601.

FIG. 8 It depicts a flowchart illustrating the operation of a configuration design unit 601.

FIG. 9 It depicts an explanatory diagram showing an example of the data obtained and utilized as “resource usage data” in the present disclosure.

FIG. 10 It depicts an explanatory diagram showing an operational image of the function for utilizing resource usage amounts by the resource usage management unit 102.

FIG. 11A It depicts an image diagram showing a specific example of the “concretization operation” performed by the configuration design unit 103.

FIG. 11B It depicts an image diagram showing a specific example of the “concretization operation” performed by the configuration design unit 103.

FIG. 12A It depicts an image diagram showing a specific example of the “concretization operation” performed by the configuration design unit 103.

FIG. 12B It depicts an image diagram showing a specific example of the “concretization operation” performed by the configuration design unit 103.

FIG. 13 It depicts a schematic block diagram showing the configuration of a computer.

FIG. 14 It depicts a block diagram showing the main parts of a system power-saving operation device.

### DESCRIPTION OF THE PREFERRED EMBODIMENTS

This present disclosure relates to methods for operating a target system, which is composed of reconfigurable information processing devices, in a power-saving manner. Specifically, it involves analyzing resource usage conditions within the target system, calculating a system configuration optimized for power consumption while maintaining the required Quality of Service (QoS), and continuously updating the target system to a power-saving configuration during operation.

The automatic design of power-saving configurations for general systems typically reduces to an optimal matching problem between “application instances (hereinafter referred to simply as ‘instances’) running the services” and the “integrated servers included in the system,” aiming to minimize power consumption. General systems cannot reconfigure the structure of integrated servers during operation. Therefore, minimizing power consumption in such systems only requires determining “which instance is operated on which integrated server.”

In contrast, DAG systems allow for the dynamic recombination of each DAG node's configuration, necessitating consideration of combinations between the instances and various device groups. To achieve a power-saving operational method that leverages the flexibility of DAG systems, a method for calculating the optimal DAG system configuration that minimizes power consumption among all possible combinations is required.

Furthermore, to calculate the optimal DAG system configuration, it is necessary to obtain data on resource consumption and power usage by each device when used for operating application instances. This requires not only load data measured for the entire information processing device as a unit but also a mechanism to analyze measurement data associated with “each device constituting the information processing device” and “each instance hosted on the information processing device.”

### EXAMPLE EMBODIMENT 1

### Description of Configuration

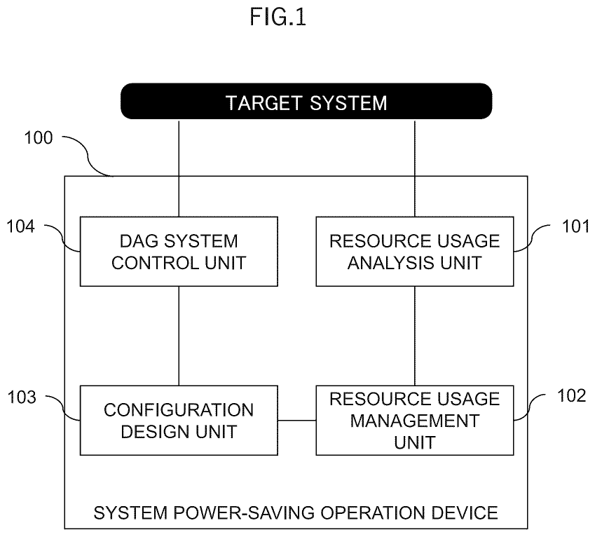

The first example embodiment of this present disclosure will be explained below with reference to the drawings. FIG. 1 is a block diagram illustrating a configuration example of a system power-saving operation device according to the present disclosure.

A system power-saving operation device 100 in this example embodiment includes a resource usage analysis unit 101. The resource usage analysis unit 101 analyzes the resource usage status of a target system and analyzes the resource usage associated with services and devices.

The system power-saving operation device 100 in this example embodiment includes a resource usage management unit 102. The resource usage management unit 102 manages the resource usage data analyzed by the resource usage analysis unit 101 and outputs the required resource usage data upon request.

The system power-saving operation device 100 in this example embodiment includes a configuration design unit 103. The configuration design unit 103 takes system requirements related to services operated on the target system as input and designs and outputs a system configuration proposal (configuration plan) that minimizes power consumption.

The system power-saving operation device 100 in this example embodiment includes a DAG system control unit 104. The DAG system control unit 104 takes a system configuration proposal (configuration plan) for the target system as input and controls the number of DAG nodes, device configurations, and running application instances in the target system.

The following provides additional explanation of the operation of the resource usage management unit 102 in this example embodiment. As explained above, the resource usage management unit 102 in this example embodiment has a function to manage resource usage data. The “management of data” function referred to here includes both a function of “storing data” and a function of “utilizing data.”

First, the resource usage management unit 102 in this example embodiment functions as a database for storing resource usage data.

Second, the resource usage management unit 102 in this example embodiment has a function to output resource usage data upon request. This request includes three pieces of information: “information specifying the type of resource usage,” “information specifying the range of resource usage to be utilized,” and “service load.” This function enables, for example, the following three types of functional examples.

(Function Example 1) Outputs “CPU usage rate when instance A running on CPU D is subjected to load [A].”

(Function Example 2) Outputs “RAM usage when instance A is subjected to load [A].”

(Function Example 3) Outputs “dynamic power consumption when instance A running on device D is subjected to load [A].”

The above provides additional explanation of the operation of the resource usage management unit 102 in this example embodiment.

The following explains the configuration of the “DAG system” in this example embodiment and the necessary matters of service operation on the DAG system.

In this example embodiment, the “DAG system” is defined as a system that includes a group of devices composed of components necessary to configure an information processing device (hereinafter referred to as “DAG device group”) and has a mechanism to interconnect and operate them.

The DAG system may function as a virtual information processing device by connecting all the components required to operate as a unified information processing device. This virtual information processing device is referred to as a “DAG node.”

The DAG system may also connect DAG nodes to each other via network interfaces connected to the DAG nodes.

With the aforementioned mechanism, the DAG system can be operated in the same manner as a general system realized by integrated servers interconnected via a network.

Additionally, the DAG system is assumed to have a management mechanism, which is part of an overarching control mechanism, enabling dynamic updates to the connection relationships of individual devices and connections between DAG nodes.

Meanwhile, in this example embodiment, a “service” refers to a single specific application. Operating a service on the system means running one or more processes generated by launching the application. Each of these processes is referred to as an “instance” (of the service) in this example embodiment.

### Description of Operation

The system power-saving operation device 100 in this example embodiment controls the configuration of a DAG system to be operated (hereinafter referred to as the “target operation system”) and enables continuous operation while reducing power consumption.

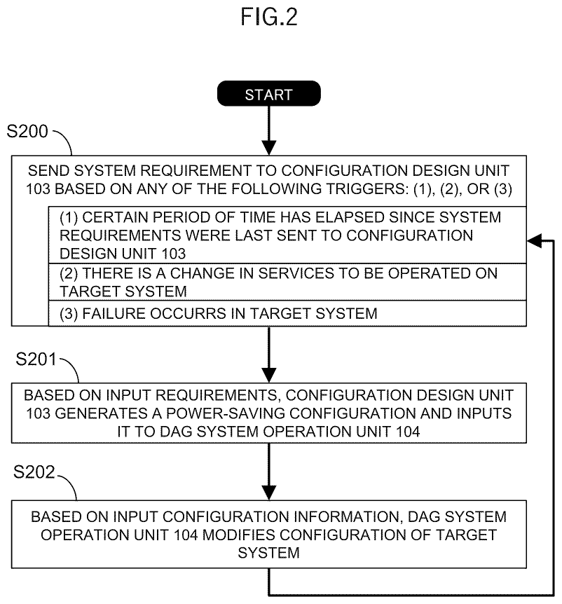

The following explains an operational outline of the system power-saving operation device 100 when operating the target system in this example embodiment. FIG. 2 depicts a flowchart illustrating an overall outline of an operation of the system power-saving operation device 100 when performing power-saving operation on the target system.

First, the resource usage analysis unit 101 or the DAG system control unit 104 provides input (system requirements) to the configuration design unit 103. The timing of this input is not restricted to specific situations in this disclosure, but the following three cases are considered as examples. (Step S200)
(Case 1) At predetermined intervals set in the resource usage analysis unit 101, the resource usage analysis unit 101 sends system requirements to the configuration design unit 103.
(Case 2) When there is a change (addition, modification, or deletion) in the services to be operated on the target system, the DAG system control unit 104 sends system requirements reflecting the service changes to the configuration design unit 103.
(Case 3) In cases such as when a failure occurs in the target system or when there is a sudden change in service load, the DAG system control unit 104 sends system requirements reflecting necessary measures to the configuration design unit 103.

The configuration design unit 103, upon receiving the system requirements, generates a power-saving configuration that meets these requirements and sends the configuration information representing the generated power-saving configuration to the DAG system control unit 104. (Step S201)

The DAG system control unit 104, upon receiving the configuration information, modifies the configuration of the target system based on the configuration information. The process then returns to Step S200. The DAG system control unit 104 continues operating the target system in the modified configuration until the next configuration change timing arises. (Step S202)

The above explains the operational outline of the system power-saving operation device 100 in this example embodiment when operating the target system.

The following explains the detailed processing of each component of the system power-saving operation device 100.

As a premise for the descriptions in this section, the following assumptions are made regarding “resource usage,” “available devices,” “power consumption,” and “service load.”

In explaining the operation in this example embodiment, it is necessary to handle the concept of resource consumption required for the system to operate normally. Various resources must be considered from different perspectives. For example, CPU usage rate, memory usage, storage capacity, and network bandwidth are examples of such resources.

For simplicity in explaining the operation in this example embodiment, only two resources related to service operation, namely “CPU usage rate” and “memory usage,” are considered. Therefore, the devices constituting the DAG node are limited to the CPU and RAM for this explanation. However, the system power-saving operation device according to this disclosure may equally consider other resource quantities and devices mentioned above.

Additionally, in this disclosure, the power consumption of devices is divided into two types: “static” power consumption, which results from the device being powered on, and “dynamic” power consumption, which results from running instances on the device. In other words, the power consumption of a DAG node is considered to be the sum of the static power consumption of all devices constituting the DAG node and the dynamic power consumption originating from instances operating on the DAG node.

Furthermore, resource usage and (dynamic) power consumption are assumed to increase depending on the load applied to the instance (for example, the utilization load of the service). Such “load” may depend on various factors depending on the service. For example, the “load” may increase with the size of specific data included in the input, or it may increase proportionally to the number of requests per unit time.

For simplicity in explaining the operation in this example embodiment, the “load” of all services is assumed to be the “size of data input per unit time.” However, this disclosure does not limit the “load” to this definition alone; different scales may be introduced for each service.

The above outlines the assumptions regarding resource usage, available devices, and service “load” for explaining the operation in this example embodiment.

Next, an operation of the resource usage analysis unit 101 in this example embodiment will be explained.

The resource usage analysis unit 101 in this example embodiment analyzes the resource usage status of the target system at predetermined intervals and acquires resource usage data associated with services and devices.

Here, the term “resource usage data” as used in this disclosure is explained.

In this disclosure, “resource usage data” refers to a “measurement value” associated with “attribute data.” The “attribute data” is tag information including, for example, “device model” and “service.” The “measurement value” in this example embodiment includes “service load,” “CPU usage rate,” “memory usage,” and “power consumption.”

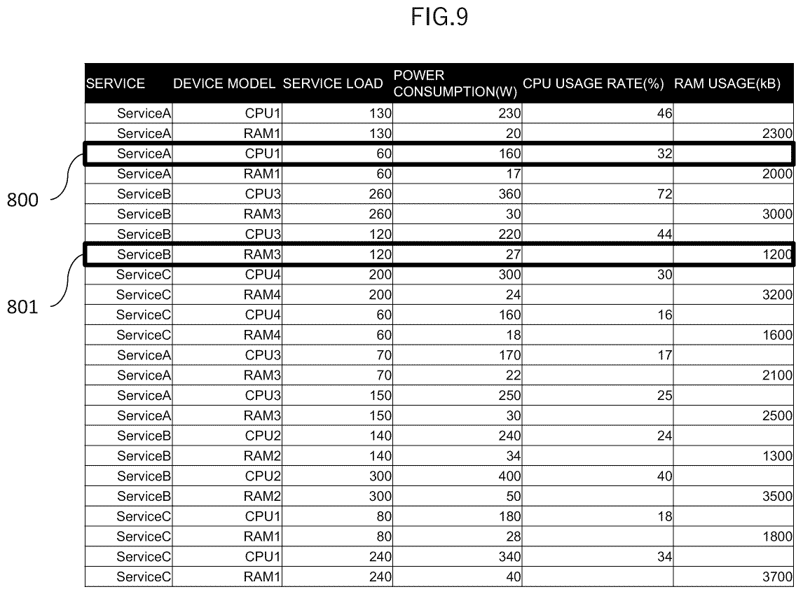

Resource usage data indicates that the resource usage under the conditions shown by the “attribute data” corresponds to the values shown in the “measurement value.” FIG. 9 illustrates an example of data acquired as resource usage data. In FIG. 9, 24 pieces of resource usage data are shown. Data 800 indicates that “when an instance of Service A is under a service load of 60, 32% of the CPU 1 utilization (where the instance is hosted) is consumed, and the power consumption attributable to this is 160 W.” Data 801 indicates that “when an instance of Service B is under a service load of 120, 1200 kB of memory capacity of RAM 3 (connected to the DAG node hosting the instance) is consumed, and the power consumption attributable to this is 27 W.”

The above explains the “resource usage data” in this disclosure.

Next, an operation by which the resource usage analysis unit 101 in this example embodiment acquires resource usage is explained.

The specific operation of the resource usage analysis unit 101 in acquiring resource usage varies depending on the type of resource usage to be acquired. This example embodiment adopts all or part of the following four methods.
(Method 1) Acquisition of information using an OOB (Out of Band) method by the management mechanism of the chassis or equipment board (BMC, Baseboard Management Controller) that houses each device. The resource usage analysis unit 101 sends API (Application Programming Interface) requests to the OOB interface provided by the BMC to acquire the necessary information. Using this method, for example, sensor information such as power consumption measured by sensors mounted in the chassis and device load information obtained via the BMC interface can be acquired.
(Method 2) Acquisition of management information via the management mechanism of the system-wide control mechanism in the DAG system. The resource usage analysis unit 101 sends API requests to the interfaces of hardware that manage the DAG system configuration to obtain the necessary information. Using this method, it is possible to acquire information such as the specifications of each device, the power state of each device, and the state of the connection relationships between devices.
(Method 3) Acquisition of management and performance information via the functionality of the operating system (OS). The resource usage analysis unit 101 acquires the required information by referencing device information managed by the OS or by executing OS-embedded commands. Using this method, device information managed by the OS can be obtained.
(Method 4) Acquisition of management and performance information via the functionality of an information acquisition agent installed on the OS. An information acquisition agent software is installed on the OS. By communicating with the resource usage analysis unit 101 through the functions of the information acquisition agent, the resource usage analysis unit 101 acquires the necessary information.

The above are specific examples of data acquisition methods that the resource usage analysis unit 101 may adopt to acquire resource usage. The resource usage analysis unit 101 in this example embodiment may adopt other information acquisition methods as needed or may not adopt any of the methods listed above.

The resource usage analysis unit 101 registers the acquired resource usage data with the resource usage management unit 102. That is, the resource usage data obtained by the resource usage analysis unit 101 is managed by the resource usage management unit 102.

The above explains the operation of the resource usage analysis unit 101 in this example embodiment.

Next, an operation of the resource usage management unit 102 in this example embodiment is explained.

As explained earlier, the functionality of the resource usage management unit 102 in this example embodiment may be divided into data storage functionality and data utilization functionality.

For the data storage mechanism in the resource usage management unit 102 in this example embodiment, a mechanism similar to a general relational database management system (RDBMS) may be adopted. For example, this storage functionality may be implemented with an existing relational database management system as the backend.

Next, an operation of a resource usage utilization functionality of the resource usage management unit 102 in this example embodiment is explained using drawings.

The resource usage management unit 102 in this example embodiment outputs resource usage based on the following three pieces of information: “information specifying the type of resource usage” (hereinafter referred to as “data type specification”), “information specifying the range of resource usage to be utilized” (hereinafter referred to as “data filter”), and “service load.”

The “data type specification” refers to information specifying either “CPU usage rate,” “memory usage,” or “power consumption” in this example embodiment.

The “data filter” is a set of attribute data associated with the resource usage data. For example, “Service: Service A, Device Model: CPU 1” corresponds to this.

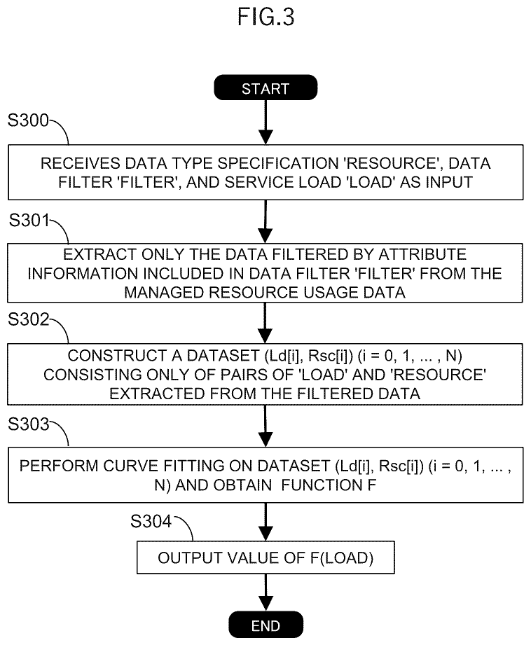

The detailed operation of the resource usage utilization functionality of the resource usage management unit 102 in this example embodiment is explained. FIG. 3 illustrates the detailed operation of the resource usage utilization functionality of the resource usage management unit 102 in this example embodiment.

The resource usage management unit 102 receives the data type specification RESOURCE, the data filter FILTER, and the service load LOAD as input. (Step S300)

The resource usage management unit 102 extracts only the data filtered by the attribute information included in the data filter FILTER from the managed resource usage data. (Step S301)

The resource usage management unit 102 constructs a data set (Ld[i], Rsc[i]) (i=0, 1, . . . , N) by extracting consisting only the pair of data of “load” and “RESOURCE” from the data extracted in Step S301. (Step S302)

The resource usage management unit 102 performs curve fitting on the dataset (Ld[i], Rsc[i]) (i=0, 1, . . . , N). Specifically, it finds a single-variable function f that minimizes the value of |Rsc[0]−f(Ld[0])|+|Rsc[1]−f(Ld[1])|+ . . . +|Rsc[N]−f(Ld[N])|. Here, |x| denotes the absolute value of x. (Step S303)

(Note) The function f determined in Step S303 may be subject to appropriate constraints. For example, f might be restricted to forms such as “a linear function,” “a polynomial function,” or “a monotonically increasing quadratic function,” and the best-fitting function under such constraints is sought.

The resource usage management unit 102 outputs the value of f (LOAD). (Step S304)

The above provides a detailed explanation of the operation of the resource usage management unit 102 in utilizing resource usage functionality.

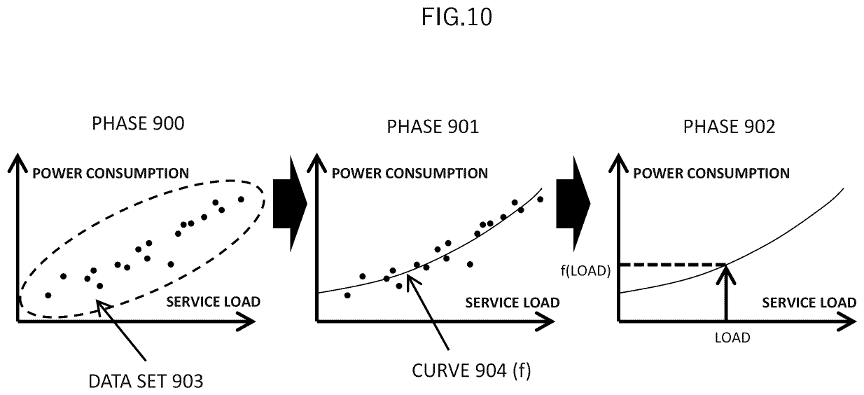

The following explains a specific example of an operation of the resource usage management unit 102 in utilizing resource usage functionality with reference to drawings. FIG. 10 depicts an explanatory diagram showing an operational image of the function for utilizing resource usage amounts by the resource usage management unit 102.

In FIG. 10, phases 900, 901, and 902 correspond to the execution images of steps S302, S303, and S304 in FIG. 3, respectively. FIG. 10 depicts an execution image where “power consumption” is specified as the RESOURCE.

The left part in FIG. 10 illustrates, in phase 900, how group data (service load, power consumption) selected by FILTER is extracted as a data set 903.

The central part in FIG. 10 illustrates, in phase 901, the calculation of a curve 904(f) that best fits a data set 903 In this case, the operation assumes f is restricted to monotonically increasing quadratic curves.

The right part in FIG. 10 illustrates, in phase 902, the calculation of the power consumption f(LOAD) estimated based on curve 904(f).

The above explains the specific example of the operation of the resource usage utilization functionality of the resource usage management unit 102 in this example embodiment.

Using the resource usage utilization functionality of the resource usage management unit 102 in this example embodiment, the static power consumption of a device can be determined.

Assume that the function of using the resource usage amount of the resource usage management unit 102 in this example embodiment is used to determine the static power consumption of the device D. In this case, for example, an appropriate service S is selected, only “service S” is specified as the data filter, “power consumption” is specified as the data type, and the value when the load is 0 is output.

However, the method of determining the static power consumption of the device D using the resource utilization function of the resource usage management unit 102 is not limited to the procedure explained above. Instead of using the value obtained by selecting a single appropriate service as explained, it is also possible to calculate the average value of the static power consumption determined for multiple services following the same procedure and use this average as the static power consumption of device D.

The above explains the operation of the resource usage management unit 102 in this example embodiment.

Next, an operation of the configuration design unit 103 in this example embodiment is explained.

The configuration design unit 103 takes the system requirements of the target system as input and outputs a configuration of the target system that correctly meets the system requirements while minimizing power consumption.

In this example embodiment, the configuration design unit 103 designs the configuration of the DAG system using a method similar to that explained in Document 1 (Japanese Patent Application Publication No.2021-135625). That is, the configuration design unit 103 starts with information necessary to generate valid configuration information, and by gradually concretizing this, generates a configuration proposal (=a partially concretized system configuration). Then, the configuration design unit 103 finally obtains a completely concretized configuration (=a system that can operate normally).

The “gradually concretizing” explained above mainly assumes the following two types in this example embodiment: (1) Deciding the hosting location of instances, and (2) Selecting the components of devices that constitute nodes. These concretizations are accompanied by quantitative constraints on resources used by instances and resources supplied by devices. Therefore, similar to the method described in the Document 1, as concretization is applied, constraints that each configuration proposal must satisfy accumulate, and at the same time, the satisfiability of these constraints is ensured through satisfiability checks. This mechanism allows the configuration design unit 103 in this example embodiment to consistently output a system configuration that is valid concerning resource usage.

Additionally, in this example embodiment, the configuration design unit 103 includes a mechanism to estimate the estimated power consumption for each configuration proposal and prioritize the concretization of those with the smallest estimated power consumption. This mechanism enables the configuration design unit 103 to proceed with the design, aiming for a system configuration with the smallest estimated power consumption.

Through the mechanism explained above, the configuration design unit 103 in this example embodiment outputs a configuration with the smallest estimated power consumption among those valid concerning resource usage.

Next, the system requirements input to the configuration design unit 103 are explained in detail.

The system requirements input to the configuration design unit 103 in this example embodiment are assumed to include the following information (1) through (5). However, the system requirements input to the configuration design unit 103 in this disclosure are not limited to a specific type in terms of their format or the information contained therein.
(1) A list of devices, DEVICEs, specifying which devices can be used as part of the DAG system configuration.
(2) A list of instances, INSTANCEs, representing the services to be operated on the DAG system.
(3) Information, is_available[A, D], indicating whether each device D included in DEVICEs can be used for operating each instance A included in INSTANCEs.
(4) Information, is_coexistable[A1, A2], indicating whether instances A1 and A2 included in INSTANCEs can be operated on the same DAG node.
(5) The estimated load, load[A], for each instance A included in INSTANCEs.

The above is the explanation of the system requirements input into the configuration design unit 103.

Next, the configuration proposals of the DAG system (partially or fully concretized system configurations) handled by the configuration design unit 103 in this example embodiment and conditions for completion of concretization are explained.

In this example embodiment, a “configuration proposal” refers to a data structure T representing a set of relationships HOST(A, N) between instance A and node N, and CONNECT(D, N) between device D and node N. When HOST(_,N) or CONNECT(_,N) is included in the configuration proposal T, it is said that “node N is included in the configuration proposal T.”

In this example embodiment, it is assumed that exactly one CPU is connected to each DAG node, while the number of connected RAM devices may vary. The lower and upper bounds of the number of connected RAM devices are denoted as LB_RAM and UB_RAM, respectively, with LB_RAM≤UB_RAM. These values may be the same, in which case the number of connected RAM devices is fixed.

Based on the above assumptions, in this example embodiment, a configuration proposal T is considered “fully concretized” when it meets the following conditions (C1), (C2), and (C3).
(C1) HOST(A, N) is included in configuration proposal T for every instance A included in INSTANCEs.
(C2) The number of RAMs connected to all nodes N included in the configuration proposal T (that is, the number of RAM D such that CONNECT(D, N) in T) is equal to or greater than LB_RAM and equal to or less than UB RAM.
(C3) The number of CPUs connected to all nodes N included in the configuration proposal T (that is, the number of CPU D such that CONNECT(D, N) in T) is exactly one.

The above is the explanation of the configuration proposals of the DAG system (partially or fully concretized system configurations) handled by the configuration design unit 103 in this example embodiment and the conditions for completion of concretization.

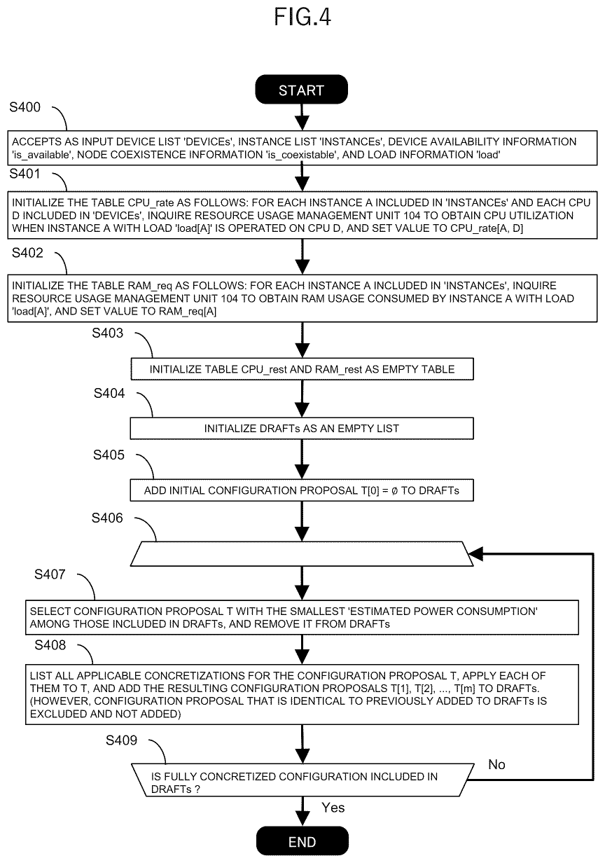

The detailed operation of the configuration design unit 103 in this example embodiment will be explained. FIG. 4 depicts a flowchart illustrating the detailed operation of the configuration design unit 103.

The configuration design unit 103 receives system requirements as input. As explained above, the system requirements include the following five data elements: the device list “DEVICEs”, the instance list “INSTANCEs”, the device availability information “is_available”, the node coexistence information “is_coexistable”, and the load information “load”. (Step S400)

The configuration design unit 103 initializes a table CPU_rate as follows. For each instance A included in INSTANCEs and each CPU D included in DEVICEs, the configuration design unit 103 queries the resource usage management unit 102 to obtain the CPU usage rate when instance A, subjected to a load load[A], is operated on CPU D. It then sets the obtained CPU usage rate in CPU_rate[A, D]. (Step S401)

The configuration design unit 103 initializes the table RAM_req as follows. For each instance A included in INSTANCEs, the configuration design unit 103 queries the resource usage management unit 102 to obtain the amount of RAM usage consumed by instance A when subjected to the load load[A]. The configuration design unit 103 then sets the obtained RAM usage in RAM_req[A]. (Step S402)

The configuration design unit 103 initializes the tables CPU_rest, representing the amount of CPU resources provided by nodes, and RAM_rest, representing the amount of RAM resources provided by nodes, as empty tables. (Step S403)

The configuration design unit 103 initializes the list of configuration proposals DRAFTs as an empty list. (Step S404)

The configuration design unit 103 adds the initial configuration proposal T[0]={ } (empty set) to DRAFTs. (Step S405)

The configuration design unit 103 repeats the procedures in steps S407 through S408 until a fully concretized configuration is found in step S409. (Step S406)

The configuration design unit 103 selects one configuration proposal T with the smallest estimated power consumption from DRAFTs and removes it from DRAFTs. (Step S407)

The configuration design unit 103 lists all applicable “concretization” operations, Hosting(A, N), Connect(D_r, N), and Create(D_c), shown below, for the configuration proposal T selected in the previous step. Here, A is an instance included in INSTANCEs, N is a node included in T, D_c is a CPU included in DEVICEs, and D_r is RAM included in DEVICEs. After that, the configuration design unit 103 adds all the configuration proposals T[1], T[2], . . . , T[m] obtained by applying each of them to T to DRAFTs. However, as an exception, a configuration proposal that is exactly the same as a configuration proposal that have been added to DRAFTs in the past will not be added. (Step S408)

“Concretization” Operation 1: Hosting (A, N)

### Applicable Conditions

(1) The configuration proposal T does not include a correspondence relation HOST(A, _).
(2) The configuration proposal T includes a correspondence relation CONNECT(D, N) for a certain CPU D.
(3) CPU_rest[T, N]≥CPU_rate[A, D] and RAM_rest[T, N]≥RAM_req[A] hold true.
(4) is_available[A, D] =True.
(5) The configuration proposal T does not include HOST(A′, N) for an instance A′ such that is_coexistable (A, A′)=True.

### Result of Concretization

A configuration proposal T′ is generated by adding HOST(A, N) to the configuration proposal T. Set CPU_rest[T′, N]=CPU_rest[T, N]−CPU_rate[A, D] and RAM_rest[T′, N]=RAM_rest[T′, N]−RAM_req[A]. For nodes N′ other than N included in the configuration proposal T, set CPU_rest[T′, N]=CPU_rest[T, N] and RAM_rest[T′, N]=RAM_rest[T, N].

“Concretization” Operation 2: Connect(D_r, N)

### Applicable Conditions

(1) The configuration proposal T does not include a correspondence relation CONNECT(D_r, _).
(2) The configuration proposal T does not include UB_RAM or more correspondence relation CONNECT(_, N).

### Result of Concretization

A configuration proposal T′ is generated by adding CONNECT(D_r, N) to the configuration proposal T. Set CPU_rest[T′, N]=CPU_rest[T, N] and RAM_rest[T′, N]=RAM_rest[T′, N]+(memory capacity of RAM D_r). For nodes N′ other than N included in the configuration proposal T, set CPU_rest[T′, N]=CPU_rest[T, N] and RAM_rest[T′, N]=RAM_rest[T, N].

“Concretization” Operation 3: Create(D_c)

### Applicable Conditions

(1) The configuration proposal T does not include a correspondence relation CONNECT(D_c, _).

### Result of Concretization

A new node N not included in the configuration proposal T is created, and a configuration proposal T′ is generated by adding CONNECT (D_c, N). Set CPU_rest[T′, N]=100 and RAM_rest[T′, N]=0. For nodes N′ other than N included in the configuration proposal T, set CPU_rest[T′, N]=CPU_rest[T, N] and RAM_rest[T′, N]=RAM_rest[T, N].

When a fully concretized configuration exists in DRAFTs, the configuration design unit 103 outputs it. Otherwise, the process returns to Step S406. (Step S409)

The above explains the detailed operation of the configuration design unit 103 in this example embodiment.

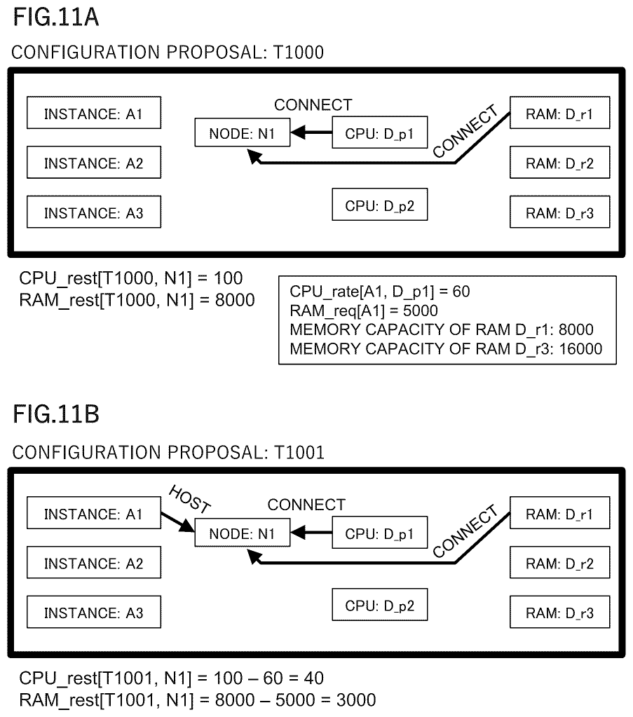

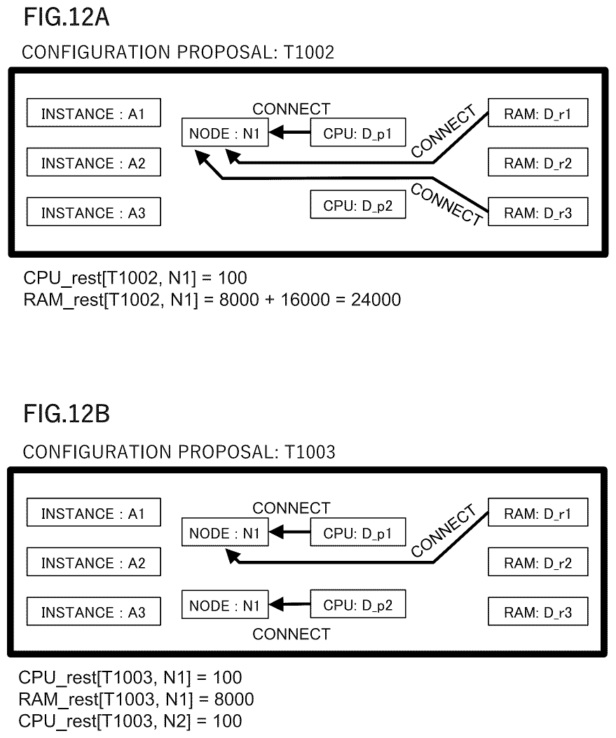

A specific example of the concretization operation executed by the configuration design unit 103 in step S408 will be explained below with reference to the drawings. FIG. 11A, FIG. 11B, FIG. 12A and FIG. 12B are illustrative diagrams showing specific examples of concretization operations.

Configuration proposal T1000 in FIG. 11A indicates the configuration proposal before concretization, which is the subject of the concretization operations in FIG. 11A, FIG. 11B, FIG. 12A and FIG. 12B. Configuration proposal T1000 includes instances: “Instance: A1”, “Instance: A2”, and “Instance: A3”, as well as node: “Node: N1”, and devices: “CPU: D_p1”, “CPU: D_p2”, “RAM: D_r1”, “RAM: D_r2”, and “RAM: D_r3”. Configuration proposal T1000 is expressed as a rectangular object in FIG. 11A and FIG. 11B. In configuration proposal T1000, CONNECT(D_p1, N1) and CONNECT(D_r1, N1) are included. CONNECT(D_p1, N1) and CONNECT(D_r1, N1) are represented as labeled arrows extending from “CPU: D_p1” to “Node: N1” and from “RAM: D_r1” to “Node: N1,” respectively. Here, assume the following values: CPU_rate[A1, D_p1]=60, RAM_req[A1]=5000, Memory capacity of RAM D_r1=8000, Memory capacity of RAM D_r3=16000, CPU_rest[T1000, N1]=100, RAM_rest[T1000, N1]=8000.

Configuration proposal T1001 in FIG. 11B is the configuration proposal after executing the concretization operation Hosting (A1, N1) on configuration proposal T1000. Configuration proposal T1001 is the configuration proposal obtained by adding HOST (A1, N1) to configuration proposal T1000. CPU_rest[T1001, N1] is calculated by subtracting CPU_rate[A1, D_p1] from CPU_rest[T1000, N1], being 40. RAM_rest[T1001, N1] is calculated by subtracting the value of RAM_req[A1] from RAM_rest[T1000, N1], being 3000.

Configuration proposal T1002 in FIG. 12A is the configuration proposal after executing the concretization operation Connect (D_r3, N1) on configuration proposal T1000. Configuration proposal T1002 is the configuration proposal obtained by adding CONNECT (D_r3, N1) to configuration proposal T1000. CPU_rest[T1002, N1] remains the same as CPU_rest[T1000, N1], being 100. RAM_rest[T1002, N1] is calculated by adding the memory capacity of RAM D_r3 to RAM_rest[T1000, N1], being 24000.

Configuration proposal T1003 in FIG. 12B is the configuration proposal after executing the concretization operation Create (D_p2) on configuration proposal T1000. Configuration proposal T1003 is the configuration proposal obtained by adding a new node N2 and CONNECT (D_p2, N2) to configuration proposal T1000. CPU_rest[T1003,N1] and RAM_rest[T1003,N1] remain unchanged from CPU_rest[T1000,N1] and RAM_rest[T1000,N1], being 100 and 8000. In addition, the value of CPU_rest[T1003,N2] is set to 100.

The above is the explanation of the specific examples of the concretization operations executed by the configuration design unit 103 in step S408.

Next, a supplement is provided regarding the “estimated power consumption” mentioned in step S407.

In the operation of the configuration design unit 103 in this example embodiment, three implementation options are provided for estimating the power consumption of configuration proposal T. However, the method for estimating the power consumption of configuration proposal T in the configuration design unit 103 is not limited to any specific method.

(Implementation Option 1) For each node N present in configuration proposal T, (1) the static power of all devices connected to N and (2) the dynamic power consumed by instance A hosted on N for each device D connected to N are queried from the resource usage management unit 102. The sum of these is regarded as the estimated power consumption of configuration proposal T.

(Implementation Option 2) The procedure of the configuration design unit 103 is executed using configuration proposal T as the initial configuration proposal. However, when adding configuration proposals to DRAFTs in step S408, only the one with the smallest “estimated power consumption” obtained by the method of “Implementation Option 1” is added. When a fully concretized configuration proposal is found using this method, the estimated power consumption of configuration proposal T is the value obtained by applying the method of “Implementation Option 1” to that configuration. When the find of a configuration proposal fails (in other words, when the DRAFTs elements run out midway), the value obtained by applying the “Implementation Option 1” method to configuration proposal T is used as the estimated power consumption.

(Implementation Option 3) The procedure of the configuration design unit 103 is executed using configuration proposal T as the initial configuration proposal. However, when adding configuration proposals to DRAFTs in step S408, only one configuration proposal is randomly selected from the possible configuration proposals and added. Multiple attempts are made to concretize using this method, and the estimated power consumption is calculated for the fully concretized configuration proposals obtained using the “Implementation Option 1” method. The smallest estimate among them is used as the estimated power consumption of configuration proposal T.

The above is the supplement regarding the “estimated power consumption.”

Next, an operation of the DAG system control unit 104 in this example embodiment is explained.

In this example embodiment, the DAG system control unit 104 performs the generation and application of the operational workflow. Here, an “operational workflow” refers to a series of tasks executed to change the operational target system from the current system configuration to the new system configuration corresponding to the configuration information designed by the configuration design unit 103. These tasks include changes in DAG node configurations, updates to connections between DAG nodes, software deployment, and stopping/starting of services.

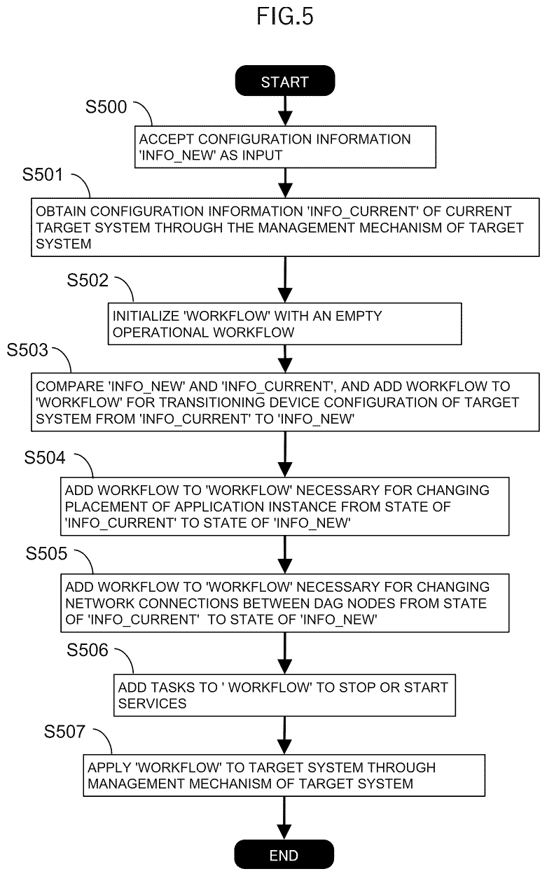

FIG. 5 depicts a flowchart illustrating the detailed operation of a DAG system control unit 104.

The DAG system control unit 104 receives the configuration information INFO_NEW as input. (Step S500)

The DAG system control unit 104 obtains the current configuration information INFO_CURRENT of the operational target system through the management mechanism of the operational target system. (Step S501)

The DAG system control unit 104 initializes the operational workflow WORKFLOW as an empty workflow that performs no operations. (Step S502)

The DAG system control unit 104 compares INFO_NEW and INFO_CURRENT. Then, the DAG system control unit 104 adds a configuration change workflow to WORKFLOW for transition the device configuration of the operational target system from INFO_CURRENT to INFO_NEW. Here, the “configuration change workflow” includes tasks such as “connecting devices,” “disconnecting devices,” “turning devices ON,” and “turning devices OFF.” The “configuration change workflow” also includes information about the execution order of the necessary tasks. (Step S503)

The DAG system control unit 104 adds a workflow to WORKFLOW for changing the placement of application instances from the state of INFO_CURRENT to the state of INFO_NEW. (Step S504)

The DAG system control unit 104 adds a workflow to WORKFLOW for changing the network connections between DAG nodes from the state of INFO_CURRENT to the state of INFO_NEW. (Step S505)

The DAG system control unit 104 adds tasks to WORKFLOW to stop or start services as needed. (Step S506)

The DAG system control unit 104 applies the operational workflow WORKFLOW to the operational target system through the management mechanism of the operational target system, thereby changing the system configuration. (Step S507)

The above is the explanation of the operation of the DAG system control unit 104 in this example embodiment.

The above is the detailed explanation of the processing of each part of the power-saving system operation device 100 in this example embodiment.

### Description of Effects

The resource usage analysis unit 101 in this example embodiment acquires data analyzed based on attributes such as “device,” “service,” and “service load” regarding the resource usage of the operational target system.

The configuration design unit 103 in this example embodiment outputs a configuration that meets all the requirements necessary for normal service operation and minimizes power consumption based on the input system requirements.

The resource usage management unit 102 in this example embodiment manages the data acquired by the resource usage analysis unit 101. Furthermore, the resource usage management unit 102 estimates and outputs the resource usage data necessary for the configuration design unit 103 to design a power-saving configuration.

The DAG system control unit 104 in this example embodiment changes the configuration of the operational target system according to the configuration information designed by the configuration design unit 103.

Thus, the system power-saving operation device 100 in this example embodiment may continuously optimize the system configuration (particularly in terms of power consumption) according to the operational status of services on the operational target system. As a result, the system power-saving operation device 100 may operate the operational target system in a power-saving manner.

### EXAMPLE EMBODIMENT 2

### Description of Configuration

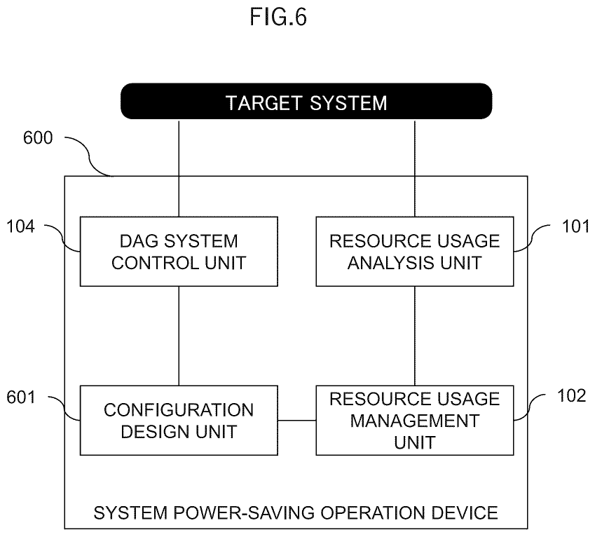

The second example embodiment of this disclosure will be explained with reference to the drawings. FIG. 6 depicts a block diagram illustrating a configuration example of the system power-saving operation device of the second example embodiment of this disclosure.

The configuration of the system power-saving operation device 600 in this example embodiment is almost identical to the system power-saving operation device 100 in the first example embodiment, except that it includes a configuration design unit 601 instead of the configuration design unit 103.

The configuration design unit 601 in this example embodiment, like the configuration design unit 103, receives system requirements regarding services operated on the operational target system as input and designs and outputs a system configuration proposal that minimizes power consumption.

### Description of Operation

The operation of the system power-saving operation device 600 in this example embodiment is identical to that of the system power-saving operation device 100 in the first example embodiment, except that the configuration design unit 601 performs the functions that were performed by the configuration design unit 103.

The detailed operation of the configuration design unit 601 in this example embodiment is explained below. The configuration design unit 601 converts the input system requirements into a set of equality and inequality constraints on binary variables (variables taking values of 0 or 1). Furthermore, the configuration design unit 601 expresses the estimated power consumption of the DAG system as an objective function. By executing these processes, the configuration design unit 601 constructs a mathematical optimization problem consisting of the above-mentioned constraints and objective function. The configuration design unit 601 then solves the constructed mathematical optimization problem to obtain a power-saving configuration.

Regarding the system requirements input to the configuration design unit 601, it is assumed, as with the configuration design unit 103, that they include the following information (1) through (5).
(1) A list of devices, DEVICEs, specifying which devices can be used as part of the DAG system configuration.
(2) A list of instances, INSTANCEs, representing the services to be operated on the DAG system.
(3) Information, is_available[A, D], indicating whether each device D included in DEVICEs can be used for operating each instance A included in INSTANCEs.
(4) Information, is_coexistable[A1, A2], indicating whether instances A1 and A2 included in INSTANCEs can be operated on the same DAG node.
(5) The estimated load, load[A], for each instance A included in INSTANCEs.

The above is the explanation of the system requirements input into the configuration design unit 601.

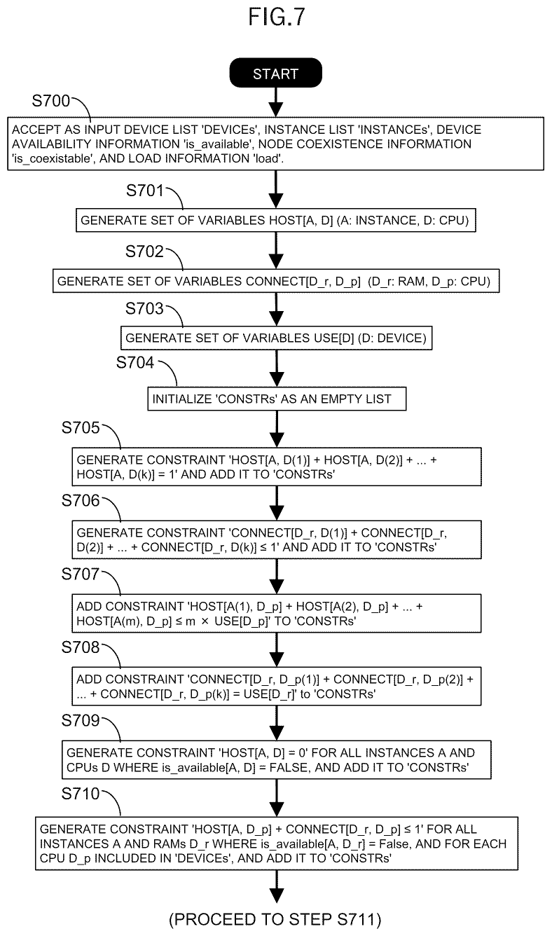

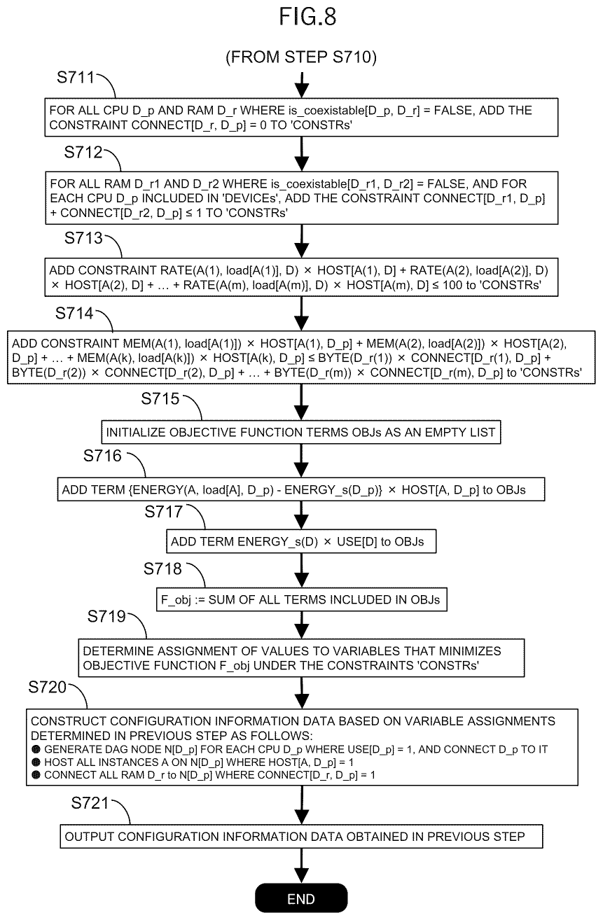

FIG. 7 and FIG. 8 depict a flowchart illustrating the operation of the configuration design unit 601.

The configuration design unit 601 receives system requirements as input. As explained above, the system requirements include the following five data elements: the device list “DEVICEs”, the instance list “INSTANCES”, the device availability information “is_available”, the node coexistence information “is_coexistable”, and the load information “load”. (Step S700)

The configuration design unit 601 generates one binary variable HOST[A, D] for each CPU D included in DEVICEs and instance A included in INSTANCEs. This is a variable that is 1 when instance A is hosted on CPU D, and 0 otherwise. (Step S701)

The configuration design unit 601 generates one binary variable CONNECT[D_r, D_p] for each RAM D_r included in DEVICEs and CPU D_p included in DEVICEs. This is a variable that is 1 when RAM D_r is connected to CPU D_p (or the DAG node to which CPU D_p is connected), and 0 otherwise. (Step S702)

The configuration design unit 601 generates one binary variable USE[D] for each device D in DEVICEs. This is a variable that is 1 when device D is used in the DAG system, and 0 otherwise. (Step S703)

The configuration design unit 601 initializes the constraint set CONSTRs as an empty list. (Step S704)

The configuration design unit 601 generates a constraint “HOST[A, D(1)]+HOST[A, D(2)]+ . . . +HOST[A, D(k)]=1” for each instance A and adds it to CONSTRs. Here, D(1), D(2), . . . , D(k) are a list of all CPUs included in DEVICEs. This constraint ensures that “Instance A is hosted on exactly one DAG node.” (Step S705)

The configuration design unit 601 generates a constraint “CONNECT[D_r, D(1)]+CONNECT[D_r, D(2)]+ . . . +CONNECT[D_r, D(k)]≤1” and adds it to CONSTRs Here, D(1), D(2), . . . , D(k) are a list of all CPUs included in DEVICEs. This constraint ensures that “Each RAM is connected to exactly one DAG node or not connected to any DAG node.” (Step S706)

The configuration design unit 601 adds the constraint “HOST[A(1), D_p]+HOST[A(2), D_p]+ . . . +HOST[A(m), D_p]≤m*USE[D_p]” to CONSTRs for each CPU D_p. Here, m is the number of elements in INSTANCEs. A(1), A(2), . . . , A(m) are a list of instances included in INSTANCEs. These represent a relationship between the variables USE and HOST. (Step S707)

The configuration design unit 601 adds the constraint “CONNECT[D_r, D_p(1)]+CONNECT[D_r, D_p(2)]+ . . . +CONNECT[D_r, D_p(k)]=USE[D_r]” to CONSTRs for each RAM D_r. Here, D_p(1), D_p(2), . . . , D_p(k) are a list of CPUs included in DEVICEs. This constraint represents a relationship between USE and CONNECT variables. (Step S708)

The configuration design unit 601 generates a constraint “HOST[A, D]=0” for all instance A and CPU D where is_available[A, D]=False, and adds it to CONSTRs. This is a constraint corresponds to “is_available” regarding CPUs and instances. (Step S709)

The configuration design unit 601 generates a constraint “HOST[A, D_p]+CONNECT[D_r, D_p]≤1” for all instance A, RAM D_r, and CPU D_p where is_available[A, D_r]=False, and adds it to CONSTRs. This is a constraint corresponds to “is_available” regarding RAM and instances. (Step S710)

The configuration design unit 601 adds a constraint “CONNECT[D_r, D_p]=0” to CONSTRs for all CPU D_p and RAM D_r where is_coexistable[D_p, D_r]=False. This is a constraint corresponds to “is_coexistable” regarding CPUs and RAM. (Step S711)

The configuration design unit 601 adds a constraint “CONNECT[D_r1, D_p]+CONNECT[D_r2, D_p]≤1” to CONSTRs for all RAMs D_r1, D_r2 where is_coexistable[D_r1, D_r2]=False, and for each CPU D_p included in DEVICEs. This is a constraint corresponds to “is_coexistable” regarding two RAMs. (Step S712)

The configuration design unit 601 adds a constraint “RATE(A(1), load[A(1)], D)* HOST[A(1), D]+RATE(A(2), load[A(2)], D)*HOST[A(2), D]+ . . . +RATE(A(m), load[A(m)], D)*HOST[A(m), D]≤100” to CONSTRs for each CPU D included in DEVICEs. Here, A(1), A(2), . . . , A(m) are a list of instances included in INSTANCEs. RATE(A(i), load[A(i)], D) is the output value obtained by querying the resource usage management unit 102 for “CPU usage rate when a load [A(i)] is applied to instance A(i) running on CPU D.” This is a constraint meaning that “the total estimated CPU usage rate by instances hosted on CPU D does not exceed 100%.”

The configuration design unit 601 adds a constraint “MEM(A(1), load[A(1)])*HOST[A(1), D_p]+MEM(A(2), load[A(2)])*HOST[A(2), D_p]+ . . . +MEM(A(k), load[A(k)])* HOST[A(k), D_p]≤BYTE(D_r(1))*CONNECT[D_r(1), D_p]+BYTE(D_r(2))* CONNECT[D_r(2), D_p]+ . . . +BYTE(D_r(m))*CONNECT[D_r(m), D_p]” to CONSTRs for each CPU D_p included in DEVICEs. Here, A(1), A(2), . . . , A(m) are a list of instances included in INSTANCEs. D_r(1), D_r(2), . . . , D_r(m) are a list of RAMs included in DEVICEs. MEM(A(i), load[A(i)]) is the output value obtained by querying the resource usage management unit 102 about “the memory usage when a load load[A(i)] is applied to instance A(i).” BYTE(D_r(i)) is the memory capacity of RAM D_r(i). These are constraints that mean “for the DAG node to which CPU D_p is connected, the required memory amount is less than or equal to the installed memory amount.” (Step S714)

The configuration design unit 601 initializes the objective function terms OBJs as an empty list. (Step S715)

The configuration design unit 601 adds the term “{ENERGY(A, load[A], D_p)−ENERGY_s(D_p)}*HOST[A, D_p]” to OBJs for each CPU D_p included in DEVICEs and instance A. Here, ENERGY (A, load[A], D_p) is the output value obtained by querying the resource usage management unit 102 about “the power consumption of D_p when a load load[A] is applied to instance A hosted on CPU D_p.” ENERGY_s(D_p) is the output value obtained by querying the resource usage management unit 102 about “the static power consumption of CPU D_p.” These correspond to the dynamic power consumption consumed by each CPU. (Step S716)

The configuration design unit 601 adds the term “ENERGY_s(D)*USE[D]” to OBJs for each device D included in DEVICEs. Here, ENERGY_s(D) is the output value obtained by querying the resource usage management unit 102 about “static power consumption of device D”. These correspond to the static power consumption consumed by each device. (Step S717)

The configuration design unit 601 sets the objective function F_obj to “the sum of all terms in OBJs.” (Step S718)

The configuration design unit 601 uses a mathematical optimization algorithm to find “a combination of value assignments of the variables HOST and CONNECT.USE that meets all of the constraints included in CONSTRs and that minimizes the objective function F_obj.” In particular, the optimization problem consisting of CONSTRs and F_obj constructed by the above-mentioned procedure is classified as a binary linear programming problem (Binary Integer Programming, BIP). Therefore, such an optimization problem can be solved by an efficient algorithm specialized for binary linear programming problems. (Step S719)

The configuration design unit 601 constructs configuration information data based on the solution obtained in step S719. Specifically, the configuration design unit 601 generates DAG nodes N[D_p] for all CPUs D_p for which USE[D_p]=1, and connects D_p. Furthermore, the configuration design unit 601 hosts all instances A for which HOST[A,D_p]=1 on N[D_p], and connects all RAMs D_r for which CONNECT[D_r,D_p]=1 to N[D_p]. (Step S720)

The configuration design unit 601 outputs the constructed configuration information. (Step S721)

The above is the detailed explanation of the operation of the configuration design unit 601 in this example embodiment.

### Effect Description

The configuration design unit 601 in this example embodiment, by utilizing a mathematical optimization algorithm, may derive configuration information faster compared to the configuration design unit 103. This capability enables the optimization of the operational target system's configuration (specifically, power consumption optimization) to be performed at shorter intervals. As a result, the configuration design unit 601 in this example embodiment may achieve further power consumption optimization.

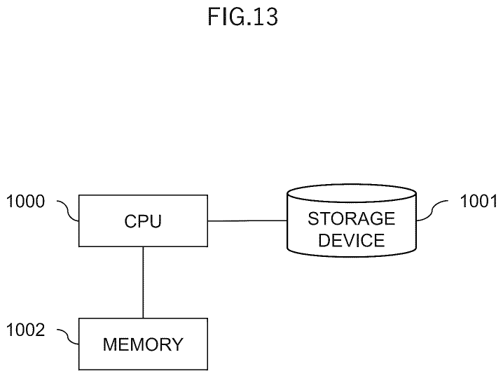

FIG. 13 is a schematic block diagram showing the configuration of a computer related to this disclosure. CPU 1000 executes processes according to the system power-saving operation program stored in the storage device 1001 to realize the functions of the system power-saving operation device 100 or the system power-saving operation device 600 explained in the above example embodiments.

That is, CPU 1000, by executing processes based on the system power-saving operation program stored in storage device 1001, realizes the functions of the resource usage analysis unit 101, the resource usage management unit 102, the configuration design unit 103, and the DAG system control unit 104 of the system power-saving operation device 100 shown in FIG. 1. Additionally, CPU 1000 realizes the functionality of the configuration design unit 601 of the system power-saving operation device 600 shown in FIG. 6 by executing processes according to the program stored in the storage device 1001.

The storage device 1001 is, for example, a non-transitory computer-readable medium. Non-transitory computer-readable media include various types of tangible storage media. Specific examples of non-transitory computer-readable media include semiconductor memory (for example, mask ROM, PROM (Programmable ROM), EPROM (Erasable PROM), flash ROM).

Memory 1002 is implemented, for example, as RAM (Random Access Memory) and temporarily stores data when CPU 1000 executes processes.

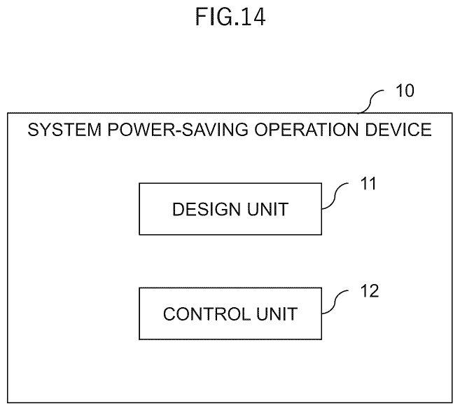

The outline of this disclosure is explained next. FIG. 14 is a block diagram showing the main parts of a system power-saving operation device. The system power-saving operation device 10 (for example, corresponding to the system power-saving operation devices 100 and 600) shown in FIG. 14 includes a design unit 11 (realized by the configuration design unit 103 or the configuration design unit 601 in the example embodiments) that designs a configuration of a DAG (disaggregated) node included in a DAG system, based on the amount of resources (for example, equivalent to “resource usage data”) required for service operation on the DAG system, so that a service can be operated at a level that meets a required performance requirement (for example, equivalent to meeting the system requirements) and power consumption is minimized, and a control unit 12 (realized by the DAG system control unit 104 in the example embodiment) that controls the configuration of the DAG node included in the DAG system based on the configuration designed by the design unit 11. With such a configuration, the system can be continuously operated with a DAG system configuration optimized in terms of power consumption according to the configuration of the service operating on the DAG system and its operation status. As a result, the DAG system can be operated in a power-saving manner.

As explained above, the present disclosure has been explained with reference to the example embodiments, but the present disclosure is not limited to the above example embodiments. Various changes can be made to the configuration and details of the present disclosure within the scope of understanding of those skilled in the art. Each example embodiment can be appropriately combined with other example embodiments.

Moreover, a part of or all of the components of the aforementioned example embodiments may be described as follows but are not limited to these descriptions.

(Supplementary note 1) A system power-saving operation device comprising:
a design unit that designs a configuration of a DAG (disaggregated) node included in a DAG system, based on the amount of resources required for service operation on the DAG system, so that a service can be operated at a level that meets a required performance requirement and power consumption is minimized; and
a control unit that controls the configuration of the DAG node included in the DAG system based on the designed configuration.

(Supplementary note 2) The system power-saving operation device according to supplementary note 1, further comprising
an analyze unit that analyzes at least one of a workload processed by the DAG system or a resource usage status of the DAG system, and estimates the amount of resources required for service operation,
wherein the design unit designs the configuration of the DAG node based on the estimated amount of resources.

(Supplementary note 3) The system power-saving operation device according to supplementary note 1 or 2, wherein
the control unit optimizes the configuration of the DAG node during an operation of the DAG system, as necessary based on the designed configuration, so that power consumption is minimized.

(Supplementary note 4) The system power-saving operation device according to any one of supplementary notes 1 to 3, wherein
the design unit takes as input a constraint that must be considered when determining a combination of an application instance and a device for service operation and, based on the constraint, repeatedly and stepwise performs at least one of selecting the DAG node to host the application instance or selecting the device that constitutes the DAG node, thereby deriving a configuration with low power consumption through tree search.

(Supplementary note 5) The system power-saving operation device according to any one of supplementary notes 1 to 3, wherein
the design unit takes as input various constraints that must be considered when determining a combination of an application instance and a device for service operation, convert the constraints into a constraint set on binary variables, convert a power consumption of the DAG system into an objective function on binary variables, and determines part or all of the configuration of the DAG system by solving a mathematical optimization problem composed of the constraint set and the objective function.

(Supplementary note 6) A system power-saving operation method comprising:
designing a configuration of a DAG (disaggregated) node included in a DAG system, based on the amount of resources required for service operation on the DAG system, so that a service can be operated at a level that meets a required performance requirement and power consumption is minimized; and
controlling the configuration of the DAG node included in the DAG system based on the designed configuration.

(Supplementary note 7) The system power-saving operation method according to supplementary note 6, further comprising:
analyzing at least one of a workload processed by the DAG system or a resource usage status of the DAG system, and estimating the amount of resources required for service operation; and
designing the configuration of the DAG node based on the estimated amount of resources.

(Supplementary note 8) The system power-saving operation method according to supplementary note 6 or 7, further comprising
optimizing the configuration of the DAG node during an operation of the DAG system, as necessary based on the designed configuration, so that power consumption is minimized.

(Supplementary note 9) The system power-saving operation method according to any one of supplementary notes 6 to 8, further comprising
taking as input a constraint that must be considered when determining a combination of an application instance and a device for service operation and, based on the constraint, repeatedly and stepwise perform at least one of selecting the DAG node to host the application instance or selecting the device that constitutes the DAG node, thereby deriving a configuration with low power consumption through tree search.

(Supplementary note 10) The system power-saving operation method according to any one of supplementary notes 6 to 8, further comprising
taking as input various constraints that must be considered when determining a combination of an application instance and a device for service operation, convert the constraints into a constraint set on binary variables, convert a power consumption of the DAG system into an objective function on binary variables, and determine part or all of the configuration of the DAG system by solving a mathematical optimization problem composed of the constraint set and the objective function.

(Supplementary note 11) A system power-saving operation program for causing a computer to execute processing comprising:
designing a configuration of a DAG (disaggregated) node included in a DAG system, based on the amount of resources required for service operation on the DAG system, so that a service can be operated at a level that meets a required performance requirement and power consumption is minimized; and
controlling the configuration of the DAG node included in the DAG system based on the designed configuration.

(Supplementary note 12) The system power-saving operation program according to supplementary note 11, wherein the processing further comprising:
analyzing at least one of a workload processed by the DAG system or a resource usage status of the DAG system, and estimating the amount of resources required for service operation; and
designing the configuration of the DAG node based on the estimated amount of resources.

(Supplementary note 13) The system power-saving operation program according to supplementary note 11 or 12, wherein the processing further comprising:
optimizing the configuration of the DAG node during an operation of the DAG system, as necessary based on the designed configuration, so that power consumption is minimized.

(Supplementary note 14) The system power-saving operation program according to any one of supplementary notes 11 to 13, wherein the processing further comprising:
taking as input a constraint that must be considered when determining a combination of an application instance and a device for service operation and, based on the constraint, repeatedly and stepwise perform at least one of selecting the DAG node to host the application instance or selecting the device that constitutes the DAG node, thereby deriving a configuration with low power consumption through tree search.

(Supplementary note 15) The system power-saving operation program according to any one of supplementary notes 11 to 13, wherein the processing further comprising:
taking as input various constraints that must be considered when determining a combination of an application instance and a device for service operation, convert the constraints into a constraint set on binary variables, convert a power consumption of the DAG system into an objective function on binary variables, and determine part or all of the configuration of the DAG system by solving a mathematical optimization problem composed of the constraint set and the objective function.

(Supplementary note 16) A non-transitory computer-readable storage medium storing a system power-saving operation program for causing a computer to execute processing comprising:
designing a configuration of a DAG (disaggregated) node included in a DAG system, based on the amount of resources required for service operation on the DAG system, so that a service can be operated at a level that meets a required performance requirement and power consumption is minimized; and
controlling the configuration of the DAG node included in the DAG system based on the designed configuration.

(Supplementary note 17) The non-transitory computer-readable storage medium according to supplementary note 16, wherein the processing further comprising:
analyzing at least one of a workload processed by the DAG system or a resource usage status of the DAG system, and estimating the amount of resources required for service operation; and
designing the configuration of the DAG node based on the estimated amount of resources.

(Supplementary note 18) The non-transitory computer-readable storage medium according to supplementary note 16 or 17, wherein the processing further comprising:
optimizing the configuration of the DAG node during an operation of the DAG system, as necessary based on the designed configuration, so that power consumption is minimized.

(Supplementary note 19) The non-transitory computer-readable storage medium according to any one of supplementary notes 16 to 18, wherein the processing further comprising:
taking as input a constraint that must be considered when determining a combination of an application instance and a device for service operation and, based on the constraint, repeatedly and stepwise perform at least one of selecting the DAG node to host the application instance or selecting the device that constitutes the DAG node, thereby deriving a configuration with low power consumption through tree search.

(Supplementary note 20) The non-transitory computer-readable storage medium according to any one of supplementary notes 16 to 18, wherein the processing further comprising:
taking as input various constraints that must be considered when determining a combination of an application instance and a device for service operation, convert the constraints into a constraint set on binary variables, convert a power consumption of the DAG system into an objective function on binary variables, and determine part or all of the configuration of the DAG system by solving a mathematical optimization problem composed of the constraint set and the objective function.

1. A system power-saving operation device comprising:
a memory storing software instructions; and
one or more processors configured to execute the software instructions to:
design a configuration of a DAG (disaggregated) node included in a DAG system, based on the amount of resources required for service operation on the DAG system, so that a service can be operated at a level that meets a required performance requirement and power consumption is minimized; and
control the configuration of the DAG node included in the DAG system based on the designed configuration.

2. The system power-saving operation device according to claim 1, wherein the one or more processors are further configured to execute the software instructions to
analyze at least one of a workload processed by the DAG system or a resource usage status of the DAG system, and estimate the amount of resources required for service operation,
wherein the one or more processors design the configuration of the DAG node based on the estimated amount of resources.

3. The system power-saving operation device according to claim 1, wherein
the one or more processors optimize the configuration of the DAG node during an operation of the DAG system, as necessary based on the designed configuration, so that power consumption is minimized.

4. The system power-saving operation device according to claim 1, wherein
the one or more processors take as input a constraint that must be considered when determining a combination of an application instance and a device for service operation and, based on the constraint, repeatedly and stepwise perform at least one of selecting the DAG node to host the application instance or selecting the device that constitutes the DAG node, thereby deriving a configuration with low power consumption through tree search.

5. The system power-saving operation device according to claim 1, wherein
the one or more processors take as input various constraints that must be considered when determining a combination of an application instance and a device for service operation, convert the constraints into a constraint set on binary variables, convert a power consumption of the DAG system into an objective function on binary variables, and determine part or all of the configuration of the DAG system by solving a mathematical optimization problem composed of the constraint set and the objective function.

6. A system power-saving operation method performed by a computer and comprising:
designing a configuration of a DAG (disaggregated) node included in a DAG system, based on the amount of resources required for service operation on the DAG system, so that a service can be operated at a level that meets a required performance requirement and power consumption is minimized; and
controlling the configuration of the DAG node included in the DAG system based on the designed configuration.

7. The system power-saving operation method according to claim 6, further comprising
analyzing at least one of a workload processed by the DAG system or a resource usage status of the DAG system, and estimating the amount of resources required for service operation; and
designing the configuration of the DAG node based on the estimated amount of resources.

8. A non-transitory computer-readable storage medium storing a system power-saving operation program for causing a computer to execute processing comprising:
designing a configuration of a DAG (disaggregated) node included in a DAG system, based on the amount of resources required for service operation on the DAG system, so that a service can be operated at a level that meets a required performance requirement and power consumption is minimized; and
controlling the configuration of the DAG node included in the DAG system based on the designed configuration.

9. The non-transitory computer-readable storage medium according to claim 8, wherein the processing further comprising:
analyzing at least one of a workload processed by the DAG system or a resource usage status of the DAG system, and estimating the amount of resources required for service operation; and
designing the configuration of the DAG node based on the estimated amount of resources.

10. The system power-saving operation device according to claim 2, wherein
the one or more processors optimize the configuration of the DAG node during an operation of the DAG system, as necessary based on the designed configuration, so that power consumption is minimized.

11. The system power-saving operation device according to claim 2, wherein
the one or more processors take as input a constraint that must be considered when determining a combination of an application instance and a device for service operation and, based on the constraint, repeatedly and stepwise perform at least one of selecting the DAG node to host the application instance or selecting the device that constitutes the DAG node, thereby deriving a configuration with low power consumption through tree search.

12. The system power-saving operation device according to claim 2, wherein
the one or more processors take as input various constraints that must be considered when determining a combination of an application instance and a device for service operation, convert the constraints into a constraint set on binary variables, convert a power consumption of the DAG system into an objective function on binary variables, and determine part or all of the configuration of the DAG system by solving a mathematical optimization problem composed of the constraint set and the objective function.

13. The system power-saving operation device according to claim 3, wherein
the one or more processors take as input a constraint that must be considered when determining a combination of an application instance and a device for service operation and, based on the constraint, repeatedly and stepwise perform at least one of selecting the DAG node to host the application instance or selecting the device that constitutes the DAG node, thereby deriving a configuration with low power consumption through tree search.

14. The system power-saving operation device according to claim 3, wherein
the one or more processors take as input various constraints that must be considered when determining a combination of an application instance and a device for service operation, convert the constraints into a constraint set on binary variables, convert a power consumption of the DAG system into an objective function on binary variables, and determine part or all of the configuration of the DAG system by solving a mathematical optimization problem composed of the constraint set and the objective function.

15. The system power-saving operation device according to claim 10, wherein
the one or more processors take as input a constraint that must be considered when determining a combination of an application instance and a device for service operation and, based on the constraint, repeatedly and stepwise perform at least one of selecting the DAG node to host the application instance or selecting the device that constitutes the DAG node, thereby deriving a configuration with low power consumption through tree search.

16. The system power-saving operation device according to claim 10, wherein
the one or more processors take as input various constraints that must be considered when determining a combination of an application instance and a device for service operation, convert the constraints into a constraint set on binary variables, convert a power consumption of the DAG system into an objective function on binary variables, and determine part or all of the configuration of the DAG system by solving a mathematical optimization problem composed of the constraint set and the objective function.
